(19) United States
(12) Patent Application Publication
(10) Pub. No.: US 2011/0244248 A1
(43) Pub. Date: Oct. 6, 2011

(54) COATING AND A METHOD OF COATING

(76) Inventors: Ying Jun Liu, Singapore (SG); Ramakrishnan Ramaseshan, Singapore (SG); Yi Xiang Dong, Singapore (SG); Kumar Abhishek, Singapore (SG)

(21) Appl. No.: 12/998,874

(22) PCT Filed: Dec. 11, 2008
(86) PCT No.: PCT/SG2008/000476

§ 371 Date: Jun. 10, 2011

(51) Int. Cl. B32B 27/02; B05D 1/12; B05D 3/06; C09D 127/20; B82Y 30/00

(52) U.S. Cl. 428/421; 427/180; 427/561; 524/546; 521/145; 977/778; 977/902

(57) ABSTRACT

The present invention provides a method of coating at least one surface of a substrate comprising the step of applying a coating comprising fibres onto the at least one surface of the substrate, wherein upon application of the coating on the at least one surface of the substrate, the surface exhibits hydrophilicity or greater hydrophilicity compared to an uncoated surface. The present invention also provides a coating for coating at least one surface of a substrate, wherein the coating comprises fibres, and wherein a surface coated with the coating exhibits hydrophilicity or greater hydrophilicity compared to an uncoated surface. The anti-wetting coating may have a high degree of transparency.

### FIELD OF THE INVENTION

The present invention provides a coating and a method of coating a surface of a substrate such that the coated surface exhibits hydrophilicity compared to an uncoated surface. In particular, the coating comprises fibres.

### BACKGROUND OF THE INVENTION

Fogging occurs by deposition of water droplets on the surface of the substrate when a cool surface is exposed to moist or humid air. This problem is well known with various clear surfaces, such as automobile windshields, optical wear including glasses, goggles, face shields, helmets, binoculars, and the like, and opaque reflecting surfaces such as glass, plastics and metals.

Coating materials are being used to prevent condensation of droplets and thus achieve the anti-fog performance. Coating materials that are used to keep the glasses transparent in foggy or rainy environment, are required to have good wettability, low or no transparency loss, sufficiently adhesive property, and stabilize the water that flows over the surface. Currently available glass coatings consist of surfactant and/or nanoparticle dispersions, either aqueous or organic and are applied to the surface of glass by a spreading treatment. The chemical nature of the surfactant and/or nanoparticle permits the glass to be transparent where the coating is applied.

For example, U.S. Pat. No. 5,030,280 discloses an anti-fog coating of poly(methylmethacrylate) on poly(carbonate) which may be applied to packaging films by means of a cloth or spraying or the like. Anionic surfactants described therein have a hydrophilic-lipophilic balance or HLB value from 2 to 13. The coating described therein, like others in prior art, readily washes away.

U.S. Pat. No. 5,451,460 describes a plastic film made of a non-ionic surfactant and a hydrophobic polymer binder. However, the patent describes polymers that are soluble in only ketone or ethers. Such ketones and ethers are not environmentally friendly. Thus, while anti-fog coating stability is an important issue, it needs to be achieved without corrupting the environment with harmful solvents.

WO 89/10106 discloses a surgical mask/face shield combination. The face shield is coated with an anti-fog coating such that as that described in U.S. Pat. No. 4,467,073. These coatings are made by combining a polymer such as poly(vinylpyrrolidone), a surfactant and a curable isocyanate functional polymer. However this coating blocks the transmission of visible light and causes a hazy surface when the coating is applied on that surface. A similar problem is found with the coating described in U.S. Pat. No. 4,478,909 which describes a coating incorporating finely divided silica to induce the anti-fog characteristics.

Other products in the market such as Rain-X, which is based on the invention described in U.S. Pat. No. 3,579,540, is a coating comprised of alkyl polysiloxane, mineral acid and solvent which achieves an anti-droplet formation function. However, these products can be applied to the glass during or after a thorough pre-cleaning. Such pre-cleaning is known to need special equipment or detergent, otherwise the performance of the coating will get severely reduced due to rupture by the dirt and stains. Moreover, conventional glass coating materials may not be able to sustain severe weather conditions, and the inevitable loss of materials necessitates frequent re-coating of the glass surface.

There is therefore a need in the art for an improved coating.

### SUMMARY OF THE INVENTION

The present invention seeks to address the problems above, and provides a coating. The present invention also provides a method of coating a surface of a substrate. The coated surface of the substrate may exhibit anti-wetting and/or anti-dust properties.

According to a first aspect, the present invention provides a method of coating at least one surface of a substrate, the method comprising the step of: applying a coating comprising fibres onto the at least one surface of the substrate, wherein upon application of the coating on the at least one surface of the substrate, the surface exhibits hydrophilicity or greater hydrophilicity compared to an uncoated surface.

According to a particular aspect, the at least one surface of the substrate onto which the coating is applied may exhibit anti-wetting and/or anti-dust properties. In particular, the at least one surface of the substrate onto which the coating is applied exhibits anti-wetting property upon liquid contact. The liquid may be water. Even more in particular, when liquid contacts at least a part of the at least one surface of the substrate onto which the coating is applied and at least a part of the fibres, the liquid is stretched between fibres to form a film over the coated surface of the substrate, thereby enabling the at least one coated surface to exhibit anti-wetting properties.

According to a particular aspect, at least one of the fibres may have a one-dimensional anisotropic structure comprising an aspect ratio such that the length of the fibre to its average diameter is ≧2. In particular, the aspect ratio is ≧5, ≧10, ≧15, ≧20, ≧26, ≧30, ≧35, ≧40, ≧45, ≧50, ≧55, ≧60, ≧65, ≧70, ≧75, ≧80, ≧85, ≧90, ≧95, ≧100.

The fibres comprised in the coating may form a mesh of fibres. The mesh of fibres may have a mesh porosity of ≧50%. In particular, the mesh of fibres may have a mesh porosity of ≧55%, ≧60%, ≧65%, ≧70%, ≧75%, ≧80%, ≧85%, ≧90%, ≧95% or ≧98%. Even more in particular, the mesh of fibres has a mesh porosity ≧95%.

The mesh of fibres are such that adjacent fibres form pores having a suitable pore size. The pore size may be of a size of 10 nm-10 mm. In particular, the pore size may be 30 nm-5 mm, 50 nm-1 mm, 100 nm-0.1 mm, 200 nm-50 μm, 300 nm-10 μm, 400 nm-5 μm, 500 nm-1 μm, 600 nm-950 nm, 700 nm-800 nm. Even more in particular, the pore size may be 100 nm-0.1 mm.

The fibres may be any suitable fibre for the purposes of the present application. For example, the fibres may have an average diameter of ≦10 μm, ≦5 μm, ≦1 μm, ≦900 nm, ≦800 nm, ≦600 nm, ≦500 nm, ≦300 nm, ≦200 nm, ≦100 nm, ≦50 nm, ≦20 nm, ≦10 nm. In particular, the fibres may have an average diameter of ≦1 μm. Even more in particular, the fibres have an average diameter of 100 nm-1 μm.

The fibres comprised in the coating may be formed from any suitable material. For example, the fibre may be formed from at least one polymer. Any suitable polymer may be used for the purposes of the present invention. The polymer may be a hydrophilic polymer, a hydrophilic polymer and/or an amphiphilic polymer. For example, the fibres may be formed from a polymer selected from the group consisting of: polyamide, polyester, polyacrylate, polysulfone (PSU), fluoropolymers, mixtures, copolymer and blends, copolymers, and terpolymers thereof. In particular, the fibres may be formed from a polymer selected from the group consisting of: polycaprolactone, polyamides, polyimides, polycarbamides, polyolefins, polyurethanes, polyethylene oxide, polylactide, poly-L-lactic acid, polygyycolide, poly(glycolic acid), polyesters, poly(vinylidene fluoride) (PVDF), poly(vinylidene fluoride-co-hexafluoropropylene) (PVDF-co-HFP), poly(DL-lactide), poly(L-lactide) (PLLA), polydioxanone, chitin, collagen either in its native form or cross-linked, silk, chitosan, poly(glutamic-co-leucine), poly-lactic-glycolide acid, poly(L-lactic acid-caprolactone), polyacrylonitrile, poly(acrylonitrile-co-methacrylate), polymethylmethacrylate (PMMA), polyvinylchloride, poly(vinylidenechloride-co-acrylate), polyethylene, polypropylene, nylon, aramid, polybenzimidazole, poly(vinyl alcohol), cellulose, cellulose acetate, cellulose acetate butylate, polyvinyl pyrrolidone-vinyl acetates, poly(bis-(2-methoxy-ethoxyethoxy))phosphazene (MEEP), poly(ethyleneimide), poly(ethylene succinate), poly(ethylene sulphide), poly(oxymethylene-oligo-oxyethylene), poly(propyleneoxide), poly(vinylacetate), polyaniline, poly(ethylene terephthalate), poly(hydroxy butyrate), SBS copolymer, poly(lactic acid), mixtures, copolymer and blends, copolymers and terpolymers thereof. In particular, the at least one polymer may be PVDF, PVDF-co-HFP, polyvinylchloride, PMMA, PLLA, nylon, PSU, or mixtures, copolymer and blends, copolymers, and terpolymers thereof.

According to a particular aspect, the at least one surface of the substrate onto which the coating is applied may exhibit anti-dust property when the fibres are electrospun fibres.

According to a particular aspect, the coating may have a high degree of transparency. For example, the coating may have a transparency of ≧90%. In particular, the coating may have a transparency of ≧95%. Even more in particular, the transparency of the coating is ≧97%.

According to a particular aspect, the fibres may be formed from any suitable method. For examples, the fibres may be electrospun fibres. In particular, the method may further comprise the steps of:
a) mixing at least one polymer and at least one solvent to form a mixture; and
b) electrospinning the mixture to form fibres.

The fibres formed may be in the form of a mesh of fibres. The steps a) and b) may be performed prior to the step of applying the coating onto the at least one surface of the substrate. Any suitable solvent may be used in step a). The solvent may be an organic solvent. Any suitable polymer may be used in step a). For example, the polymer may be as described above.

According to a particular aspect, the coated surface of the substrate may further exhibit anti-fog and/or anti-dust properties. In particular, the coated surface may repel contaminants such as dust particles.

Any suitable substrate may be used for the purposes of the method of the present invention. For example, the substrate may be selected from the group consisting of: mirror, glass, window and lens.

Another aspect of the present invention is an article of manufacture, wherein at least one surface of the article of manufacture is coated according to the method as described above. Any suitable article of manufacture may be used for the purposes of the present invention. For example, the article of manufacture may be selected from the group consisting of: mirror, glass, window and lens.

According to another aspect of the present invention, there is provided a coating for coating at least one surface of a substrate, wherein the coating comprises fibres and wherein upon application of the coating on at least one surface of the substrate, the surface exhibits hydrophilicity or greater hydrophilicity compared to an uncoated surface.

According to a particular aspect, at least one of the fibres may have a one-dimensional anisotropic structure comprising an aspect ratio such that the length of the fibre to its average diameter is ≧2. In particular, the aspect ratio may be ≧5, ≧10, ≧15, ≧20, ≧25, ≧30, ≧35, ≧40, ≧45, ≧50, ≧55, ≧60, ≧65, ≧70, ≧75, ≧80, ≧85, ≧90, ≧95, ≧100.

The fibres comprised in the coating may form a mesh of fibres. The mesh of fibres may have a mesh porosity of ≧50%. In particular, the mesh of fibres may have a mesh porosity of ≧55%, ≧60%, ≧65%, ≧70%, ≧75%, ≧80%, ≧85%, ≧90%, ≧95% or 98%. Even more in particular, the mesh of fibres has mesh porosity ≧95%.

The mesh of fibres are such that adjacent fibres form pores having a suitable pore size. The pore size may be of a size of 10 nm-10 mm. In particular, the pore size may be 30 nm-5 mm, 50 nm 1 mm, 100 nm-0.1 mm, 200 nm-50 μm, 300 nm-10 μm, 400 nm-5 μm, 500 nm 1 μm, 600 nm-950 nm, 700 nm-800 nm. Even more in particular, the pore size may be 100 nm-0.1 mm.

The fibres may be any suitable fibre for the purposes of the present application. For example, the fibre may have an average diameter of ≦10 m, ≦5 μm, ≦1 m, ≦900 nm, ≦800 nm, ≦600 nm, ≦500 nm, ≦300 nm, ≦200 nm, ≦100 nm, ≦50 nm, ≦20 nm, ≦10 nm. In particular, the fibre may have an average diameter of≦1 μm. Even more in particular, the fibres have an average diameter of 100 nm-1 μm.

The fibres comprised in the coating may be formed from any suitable material and any suitable method. For example, the fibre may be formed from at least one polymer. Any suitable polymer may be used for the purposes of the present invention. The polymer may be a hydrophilic polymer, a hydrophilic polymer and/or an amphiphilic polymer. For example, the fibres may be formed from a polymer selected from the group consisting of: polyamide, polyester, polyacrylate, polysulfone (PSU), fluoropolymers and mixtures, copolymer and blends, copolymers, and terpolymers thereof. In particular, the fibre may be formed from at least one polymer selected from the group consisting of: polycaprolactone, polyamides, polyimides, polycarbamides, polyolefins, polyurethanes, polyethylene oxide, polylactide, poly-L-lactic acid, polygyycolide, poly(glycolic acid), polyesters, poly(vinylidene fluoride) (PVDF), poly(vinylidene fluoride-co-hexafluoropropylene) (PVDF-co-HFP), poly(DL-lactide), polyp lactide) (PLLA), polydioxanone, chitin, collagen either in its native form or cross-linked, silk, chitosan, poly(glutamic-co-leucine), poly-lactic-glycolide acid, poly(L-lactic acid-caprolactone), polyacrylonitrile, poly(acrylonitrile-co-methacrylate), polymethylmethacrylate (PMMA), polyvinylchloride, poly(vinylidenechloride-co-acrylate), polyethylene, polypropylene, nylon, aramid, polybenzimidazole, poly(vinyl alcohol), cellulose, cellulose acetate, cellulose acetate butylate, polyvinyl pyrrolidone-vinyl acetates, poly(bis-(2-methoxy-ethoxyethoxy))phosphazene (MEEP), poly(ethyleneimide), poly(ethylene succinate), poly(ethylene sulphide), poly(oxymethylene-oligo-oxyethylene), poly(propyleneoxide), poly(vinylacetate), polyaniline, poly (ethylene terephthalate), poly(hydroxy butyrate), SBS copolymer, poly(lactic acid), mixtures, copolymer and blends, copolymers, and terpolymers thereof. In particular, the fibre may be formed from at least one polymer selected from the group consisting of: PVDF, PVDF-co-HFP, polyvinylchloride, PMMA, PLLA, nylon, PSU, or mixtures, copolymer and blends, copolymers, and terpolymers thereof.

According to a particular aspect, upon application of the coating on at least one surface of a substrate, the surface may exhibit anti-wetting and/or anti-dust properties. In particular, a surface may exhibit anti-dust properties when the fibres comprised in the coating are electrospun fibres.

The coating may have a high degree of transparency. For example, the coating may have a transparency of ≧90%. In particular, the coating may have a transparency of ≧95%. Even more in particular, the transparency of the coating is ≧97%.

The coating may further exhibit anti-fog and/or anti-dust properties. In particular, the coating may repel contaminants such as dust particles.

The present invention also provides an article of manufacture, wherein at least one surface of the article of manufacture is coated with the coating according to any aspect of the present invention, and wherein upon application of the coating on at least one surface of the substrate, the surface exhibits hydrophilicity or greater hydrophilicity compared to an uncoated surface. For example, the article of manufacture may be a mirror, glass, window and/or lens.

### BRIEF DESCRIPTION OF THE FIGURES

FIG. 1 shows an example of an electrospinning apparatus set-up.

FIG. 2 shows a scanning electron microscope (SEM) picture of an anti-wetting coating according to one embodiment of the present invention.

FIG. 3 shows a glass surface with one part (“A”) uncoated and another part (“B”) coated with the coating according to one embodiment of the present invention.

FIG. 4 shows the visibility through a coated glass surface (“J”) with a coating according to one embodiment of the present invention and an uncoated glass surface (“K”).

### DETAILED DESCRIPTION OF THE INVENTION

Bibliographic references mentioned in the present specification are for convenience listed in the form of a list of references and added at the end of the examples. The whole content of such bibliographic references is herein incorporated by reference.

Coating materials are often used to coat surfaces, for example, of glass, windows, windshields, and the like. Such coatings may improve the wetting character of the surface onto which it is coated. The present invention provides a coating useful for improving the wetting character of surfaces coated with the coating. For example, the surfaces coated with the coating may exhibit anti-wetting, anti-rain and/or anti-fog properties. The coating may also be useful for conferring anti-dust properties on the coated surface.

According to a first aspect, the present invention provides a method of coating at least one surface of a substrate, the method comprising the step of applying a coating comprising fibres onto the at least one surface of the substrate, the at least one surface of the substrate, wherein upon application of the coating on the at least one surface of the substrate, the surface exhibits hydrophilicity or greater hydrophilicity compared to an uncoated surface.

The at least one surface of the substrate onto which the coating is applied may be hydrophobic, hydrophilic or amphiphilic before the coating is applied. Upon application of the coating on the at least one surface of the substrate, the coated surface exhibits hydrophilicity or greater hydrophilicity compared to an uncoated surface. For example, the at least one surface of the substrate may exhibit ≧30%, ≧35%, ≧40%, ≧45%, ≧50%, ≧55%, ≧60%, ≧65%, ≧70%, ≧75%, ≧80%, ≧85%, ≧90%, ≧95%, or 100% hydrophilicity upon application of the coating. In particular, the coated surface exhibits 90% hydrophilicity compared to an uncoated surface of the substrate.

For the purposes of the present invention, a “fibre” may be prepared according to any suitable method. For example, the fibre may be prepared by electrospinning. Accordingly, the fibre may be an electrospun fibre. The fibre may be formed from any suitable material. For example, the fibre may be formed from any suitable organic or inorganic material. In particular, when the fibre is prepared by electrospinning, the fibre may be formed from a polymer.

The fibre may be in the form of: individual fibres; broken fibres (fibre rods); a fibre yarn; a web of fibres; a mesh of fibres; or a network of fibres. In particular, the fibres form a mesh of fibres. The fibre may have a one-dimensional anisotropic structure comprising an aspect ratio such that the length of the fibre to its average diameter is ≧2. For example, the aspect ratio is ≧5, ≧10, ≧15, ≧20, ≧25, ≧30, ≧35, ≧40, ≧45, ≧50, ≧55, ≧60, ≧65, ≧70, ≧75, ≧80, ≧85, ≧90, ≧95, ≧100.

The fibres comprised in the coating may form a mesh of fibres or a web of fibres. A mesh or web of fibres for the purposes of the present invention refers to a plurality of fibres which are interconnected to each other or which form a network of fibres. The space formed between adjacent fibres within the mesh of fibres is defined as a “pore”. Accordingly, reference to “pore size” for the purposes of the present invention refer to the diameter of the largest circle which can fit in the pore without touching the edges of the pore. Therefore, the pore size of the pores formed in a mesh or web of fibres may be equal to each other or different from each other, depending on whether the fibres are arranged in an orderly manner or in a random manner.

According to a particular aspect, the fibres may form a mesh of fibres having a mesh porosity of ≧50%. In particular, the mesh porosity may be ≧55%, ≧60%, ≧65%, ≧70%, ≧75%, ≧80%, ≧85% or ≧90%, ≧95% or ≧98%. Even more in particular, the mesh of fibres has a mesh porosity ≧95%. For the purposes of the present invention, “mesh porosity” refers to the measure of the void spaces or pores within a mesh of fibres or to the measure of the surface area occupied by pores relative to the total surface area covered by a mesh of fibres. For example, the mesh porosity measures the ratio of the amount of open area in a mesh of fibres to the amount of closed area in the mesh of fibres.

The pore size may be any suitable pore size. For example, the pore size may be 10 nm-10 mm. In particular, the pore size may be 30 nm-5 mm, 50 nm-1 mm, 100 nm-0.1 mm, 200 nm-50 μm, 300 nm-10 μm, 400 nm-5 μm, 500 nm-1 μm, 600 nm-950 nm, 700 nm-800 nm. Even more in particular, the pore size may be 100 nm-0.1 mm.

The fibres may be any suitable fibre for the purposes of the present application. For example, the fibres may have an average diameter of ≦10 μm, ≦5 μm, ≦1 μm, ≦900 nm, ≦800 nm, ≦600 nm, ≦500 nm, ≦300 nm, ≦200 nm, ≦100 nm, ≦50 nm, ≦20 nm, ≦10 nm. In particular, the fibres may have an average diameter of ≦1 μm. Even more in particular, the fibres have an average diameter of 100 nm-1 μm.

The fibres comprised in the coating may be formed from any suitable material. The fibre may be formed from an organic or inorganic material. The fibres may be formed from a hydrophilic polymer, a hydrophilic polymer and/or an amphiphilic material. In particular, the fibres may be formed from a hydrophilic material. The fibre may be formed from at least one polymer. Any suitable polymer may be used. For example, any electrospinnable polymer may be used. The polymer may be a hydrophilic polymer, a hydrophilic polymer and/or an amphiphilic polymer. In particular, the polymer is a hydrophilic polymer.

For the purposes of the present invention, reference to “polymer” may include one or more polymer, mixtures of polymers, copolymers, polymer blends, copolymer and blends, or terpolymers. The polymer may be selected from the group consisting of: polyamide, polyester, polyacrylate, polysulfone (PSU) and fluoropolymers. Exemplary polymers include, but are not limited to, polycaprolactone, polyamides, polyimides, polycarbamides, polyolefins, polyurethanes, polyethylene oxide, polylactide, poly-L-lactic acid, polyglycolide, poly(DL-lactide), poly(L-lactide) (PLLA), polylactide, poly(glycolic acid), polyesters, polydioxanone, poly(vinylidene fluoride) (PVDF), poly(vinylidene fluoride-co-hexafluoropropylene) (PVDF-co-HFP), polyacrylonitrile, poly(acrylonitrile-co-methacrylate), polymethylmethacrylate (PMMA), polyvinylchloride, poly(vinylidenechloride-co-acrylate), polyethylene, polypropylene, nylon, aramid, polybenzimidazole, poly(vinyl alcohol), cellulose, cellulose acetate, cellulose acetate butylate, polyvinyl pyrrolidone-vinyl acetates, poly(bis-(2-methoxy-ethoxyethoxy))phosphazene (MEEP), poly(ethyleneimide), poly(ethylene succinate), poly(ethylene sulphide), poly(oxymethylene-oligo-oxyethylene), poly(propyleneoxide), poly(vinylacetate), polyaniline, poly(ethylene terephthalate), poly(hydroxy butyrate), SBS copolymer, poly(lactic acid), poly(glutamic-co-leucine), poly-lactic-glycolide acid, poly(L-lactic acid-caprolactone), mixtures, copolymer and blends, copolymers, and terpolymers thereof. In particular, the at least one polymer may be PVDF, PVDF-co-HFP, polyvinylchloride, PMMA, PLLA, nylon, PSU, or mixtures, copolymer and blends, copolymers, and terpolymers thereof.

According to another particular aspect, the coating may have a high degree of transparency. For the purposes of the present invention, “transparency” in respect of a coating according to any aspect of the present invention is measured by measuring the average transmittance of visible light through the coating over a wavelength range of 350-800 nm. The transmittance may be measured using any suitable apparatus. For example, a spectrophotometer may be used. In particular, a UV spectrophotometer may be used, such as Unicam UV-VIS 300 series spectrophotometer with vision data system—Thermo Spectronics. For example, the coating may have a transparency of 90%. In particular, the coating may have a transparency of 95%. Even more in particular, the transparency of the coating is 97%. The transparency of a coating comprising fibres formed from nylon was measured to be 98.5%; for coating comprising fibres formed from poly(L-lactide), the transparency was measured to be 99.2%; for coating comprising fibres formed from poly(methyl methacrylate), the transparency was measured to be 98.9%; for coating comprising fibres formed from polysulfone, the transparency was measured to be 92.2%; and for coating comprising fibres formed from poly(vinylidene fluoride), the transparency was measured to be 98.7%. The transparencies were measured using a UV spectrophotometer, as explained above.

According to a particular aspect, the at least one surface of the substrate onto which the coating is applied may exhibit anti-wetting and/or anti-dust properties. For the purposes of the present invention, “anti-wetting” with reference to the coating of any aspect of the present invention refers to a condition whereby when liquid, such as water, contacts a surface coated with the coating, the liquid does not form liquid droplets and remain as such. As a result of the anti-wetting, the surface coated with the coating may result in enhanced visibility as the visibility through the surface is not blurred when liquid contacts the coated surface. The anti-wetting of the coating may be measured by its water-wettability. “Anti-rain” and “anti-fog” may also be used to mean anti-wetting. For the purposes of the present invention, “anti-dust” with reference to the coating according to any aspect of the present invention refers to a condition whereby particles, such as dust particles, are repelled from a surface onto which the coating is applied.

In particular, the at least one surface of the substrate onto which the coating is applied may exhibit anti-wetting property upon liquid contact. The liquid may be water. The liquid may be in the form of liquid droplets. Even more in particular, when liquid contacts at least a part of the at least one surface of the substrate onto which the coating is applied and at least a part of the fibres, the liquid is stretched between the fibres to form a film over the at least one surface, thereby enabling the at least one surface to exhibit anti-wetting property.

For example, when liquid contacts at least a part of a surface which is coated with a coating comprising fibres, the liquid is stretched between the fibres comprised in the coating. The liquid is stretched between and/or along the fibres and fuses with other liquid, if present. The liquid then forms a film over the coated surface of the substrate, thereby enabling the coated surface to exhibit anti-wetting properties. The fibres significantly increase the total surface tension by introducing line tension into the system. The liquid spreads along the fibre-substrate contacting line and repels air. The liquid then forms a layer or film, which minimises the energy of the system. For example, the liquid may be water.

In particular, the fibres possess high surface energy due to their one-dimensional structure, as described above. When a coating comprising the fibres is coated on a substrate surface, the fibres introduce more surface energy in the fibre-substrate system in the form of line tension. The hydrophilicity of the fibre-substrate system increases, thereby causing the coated surface to exhibit hydrophilicity or greater hydrophilicity compared to an uncoated surface. Once liquid contacts the coated surface of the substrate, the liquid falls within and/or between the pores formed in the mesh of fibres. The liquid contacts the fibres as well as the substrate. In order to minimise the total surface tension, the liquid is caused to stretch and/or spread within and/or between the pores and form a film over the coated surface. For example, the coated surface may be such that when liquid contacts the coated surface, the liquid infinitely spreads over the surface, leaving no visible drops of liquid on the surface.

According to a particular aspect, the at least one surface of the substrate onto which the coating is applied may exhibit anti-dust property when the fibres are electrospun fibres. The coated surface may repel contaminants. For the purposes of the present invention, “contaminants” with respect to any aspect of the present invention may be defined as any particle or substance, chemical or micro-organism that makes a medium less suitable for a specific use. An example of a contaminant is dust particles. During electrospinning, some residual charges get accumulated on the surface of the fibres and these charges aid to repel or remove dust and other particles, thereby achieving the self-cleaning function.

The method according to any aspect of the present invention may further comprise the steps of:
a) mixing at least one polymer and at least one solvent to form a mixture; and
b) electrospinning the mixture to form fibres.

The steps a) and b) may be performed prior to the step of applying the coating onto the at least one surface of the substrate. Any suitable solvent may be used in step a). The solvent may be an organic or inorganic solvent. Examples of suitable solvent include, but are not limited to, acetone, dimethylformamide (DMF), dichloromethane (DCM), hexafluoroisopropanol (HFIP), or mixtures thereof. The solvent may be as described in Z M Huang et al, 2003. Any suitable polymer may be used in step a). For example, the polymer may be as described above. The mixture formed in step a) may be a mixture of liquefied polymer. The polymer of step a) may be melted polymer or dissolved polymer.

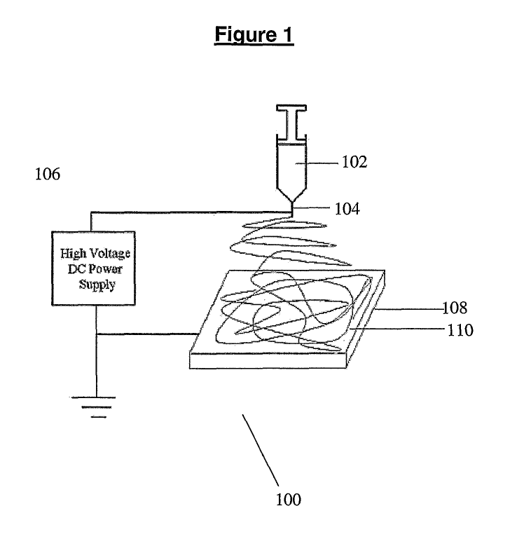

Any suitable electrospinning apparatus may be used for performing step b). For example, the electrospinning apparatus 100 may be as shown in FIG. 1. The apparatus may comprise a fluid delivery system for supplying at least one polymer material which may be in the form of a polymer solution or melt, a high voltage supply and a container for containing the polymer solution or melt. The container may comprise the mixture 102 formed in step a). The container may comprise a hole (aperture) at the bottom of the container. The fluid delivery system for electrospinning may consist of single spinneret, multiple spinnerets, co-axial spinneret, bi-capillary spinneret, multi-capillary spinneret. The spinneret 104 is used to deliver a constant supply of the at least one polymer material. A high voltage (about 10 kV) from a high voltage power supply 106 is applied to the at least one polymer or mixture formed in step a). At a critical voltage, a jet of solution of the mixture will be ejected from the tip of the spinneret and accelerate towards a surface 108, for example, a substrate surface or collector plate. The surface onto which the electrospinning jet is collected may be grounded so that the electrospinning jet is more readily deposited on the surface. The solvent from the electrospinning jet collected may evaporate upon cooling, or extracted by a suitable non-solvent on the surface, thereby forming fibres 110. Electrospinning is able to produce fibres having a suitable diameter. In particular, the average diameter of the fibres may be as described above.

In particular, the electrospinning apparatus may comprise an extruder (or dispenser) for the mixture formed in step a), a high voltage DC power supply and a collector plate that is grounded. To generate a coating layer, a liquefied polymer (e.g., melted polymer or dissolved polymer) is extruded, for example using a pump, or under the action of gravity, through a minute capillary aperture. Once the droplet meniscus of the extruded liquefied polymer forms, a process of solvent evaporation or cooling or extraction starts, which is accompanied by the creation of capsules with a semi-rigid envelope or crust. An electric field is generated by the potential difference between the extruder and precipitation surface. Because the liquefied polymer posses a certain degree of electrical conductivity, the capsules become charged. Electric forces of repulsion between the molecular chains within the capsules lead to a drastic increase in hydrostatic pressure. The semi-rigid envelopes are stretched, and a number of point micro-ruptures are formed on the surface of each envelope leading to spraying of ultra-thin jets of liquefied polymer from dispenser. Under the effect of a Coulomb force, the jets depart from the aperture of the extruder and travel towards the opposite precipitation surface, which is always grounded. Moving with high velocity in the space between the extruder and precipitation surface, the jet cools or solvent therein evaporates, or extracted by any suitable non-solvent on the precipitation surface, thus forming fibres which are collected on the precipitation surface.

According to a particular embodiment of the present invention, the extruder and precipitation surface are constructed such that the liquefied polymer emerges from the extruder and forms a plurality of polymer fibres moving towards the precipitation surface. Hence, the extruder and the precipitation surface are kept under a strong potential difference that is generated by an electric field between.

According to a particular aspect, the fibres may be formed from the following polymers and under the conditions provided in Table 1. In particular, a piece of glass was placed 10 cm under the spinneret and the time for collecting the fibres on about 150 cm² of the glass surface was measured.

TABLE 1
Properties of different fibres formed from electrospinning

| | | Concentration | | Collecting |
|---|---|---|---|---|
| | | of polymer in | Voltage | time |
| Polymer | Solvent | solvent (%) | applied (kV) | (seconds) |
| PVDF-co-HFP | DMF | 10 | 10 | 4 |
| PLLA | DCM/DMF | 2 | 7 | 10 |
| | (70:30) | | | |
| PMMA | DMF | 20 | 10 | 2 |
| Nylon | HFIP | 10 | 12 | 4 |
| PSU | DMF | 20 | 15 | 2 |

The coating may have an appropriate thickness. For example, the coating may have a thickness which may be greater than or equal to the average diameter of the fibres. According to a particular aspect, the thickness may be greater than or equal to the average diameter of a fibre but not more than about 10 times the average diameter of a fibre. In particular, the thickness is not more than about 9, 8, 7, 6, 5, 4, 3 or 2 times the average diameter of the fibre. Even more in particular, the thickness of the coating is about 2-3 times the average diameter of a fibre. The average diameter of a fibre may be as described above. The coating may be a single layer or more than two layers on the at least one surface of the substrate.

The method of the present invention does not require a pre-cleaning step. In particular, the at least one surface of the substrate need not be pre-cleaned prior to the step of applying the coating.

Any suitable substrate may be used for the purposes of the present invention. For example, the substrate may be one which requires at least one of its surfaces to have anti-wetting, anti-rain, anti-fog and/or anti-dust properties. For example, the substrate may be a mirror, a glass, a window, lens, automobile or aeroplane windshield, face shields, goggles, and the like.

According to another aspect, the present invention provides an article of manufacture, wherein at least one surface of the article of manufacture is coated by a method according to any aspect of the present invention. For example, the method may be as described above. The article of manufacture may be any suitable article of manufacture. In particular, the article of manufacture may be one which requires at least one of its surfaces to have anti-wetting, anti-rain, anti-fog and/or anti-dust properties. The article of manufacture may be a mirror, glass, window and/or lens.

According to another aspect, the present invention provides a coating for coating at least one surface of a substrate, wherein the coating comprises fibres, and wherein upon application of the coating on at least one surface of the substrate, the surface exhibits hydrophilicity or greater hydrophilicity compared to an uncoated surface.

The at least one surface of a substrate onto which the coating is applied may be hydrophobic, hydrophilic or amphiphilic before the coating is applied. Upon application of the coating on the at least one surface of a substrate, the coated surface exhibits hydrophilicity or greater hydrophilicity compared to an uncoated surface. For example, the at least one surface of the substrate may exhibit ≧30%, ≧35%, ≧40%, ≧45%, ≧50%, ≧55%, ≧60%, ≧65%, ≧70%, ≧75%, ≧80%, ≧85%, ≧90%, ≧95%, or 100% hydrophilicity upon application of the coating. In particular, the coated surface exhibits ≧90% hydrophilicity compared to an uncoated surface of the substrate.

The fibres comprised in the coating may be as described above. For example, the fibres may be in the form of: individual fibres; broken fibres (fibre rods); a fibre yarn; a web of fibres; a mesh of fibres; or a network of fibres. In particular, the fibres form a mesh of fibres. The fibre may have a one-dimensional anisotropic structure comprising an aspect ratio such that the length of the fibre to its average diameter is ≧2. For example, the aspect ratio is ≧5, ≧10, ≧15, ≧20, ≧25, ≧30, ≧35, ≧40, ≧45, ≧50, ≧55, ≧60, ≧65, ≧70, ≧75, ≧80, ≧85, ≧90, ≧95, ≧100.

The fibres comprised in the coating may form a mesh of fibres or a web of fibres. A mesh or web of fibres may be as defined above. According to a particular aspect, the fibres may form a mesh of fibres having a mesh porosity of ≧50%. In particular, the mesh porosity may be ≧55%, ≧60%, ≧65%, ≧70%, ≧75%, ≧80%, ≧85% or ≧90%, ≧95% or ≧98%. Even more in particular, the mesh of fibres has a mesh porosity ≧95%. “Mesh porosity” may be as defined above.

The mesh of fibres may form pores of suitable pore sizes. Pore size may be as defined above. For example, the pore size may be 10 nm-10 mm. In particular, the pore size may be 30 nm-5 mm, 50 nm-1 mm, 100 nm-0.1 mm, 200 nm-50 μm, 300 nm-10 μm, 400 nm-5 μm, 500 nm-1 μm, 600 nm-950 nm, 700 nm-800 nm. Even more in particular, the pore size may be 100 nm-0.1 mm.

The fibres may be any suitable fibre for the purposes of the present application. For example, the fibres may have an average diameter of ≦10 μm, ≦5 μm, m, ≦900 nm, ≦800 nm, ≦600 nm, ≦500 nm, ≦300 nm, ≦200 nm, ≦100 nm, ≦50 nm, ≦20 nm, ≦10 nm. In particular, the fibres may have an average diameter of ≦1 μm. Even more in particular, the fibres have an average diameter of 100 nm-1 μm.

The fibres comprised in the coating may be formed from any suitable material. The fibre may be formed from an organic or inorganic material. The fibres may be formed from a hydrophilic polymer, a hydrophilic polymer and/or an amphiphilic material. In particular, the fibres may be formed from a hydrophilic material. The fibre may be formed from at least one polymer. Any suitable polymer may be used. For example, any electrospinnable polymer may be used. The polymer may be a hydrophilic polymer, a hydrophilic polymer and/or an amphiphilic polymer. In particular, the polymer is a a hydrophilic polymer.

For the purposes of the present invention, reference to “polymer” may include one or more polymer, mixtures of polymers, copolymers, polymer blends, copolymer and blends, or terpolymers. The polymer may be selected from the group consisting of: polyamide, polyester, polyacrylate, polysulfone (PSU) and fluoropolymers. Exemplary polymers include, but are not limited to, polycaprolactone, polyamides, polyimides, polycarbamides, polyolefins, polyurethanes, polyethylene oxide, polylactide, poly-L-lactic acid, polyglycolide, poly(DL-lactide), poly(L-lactide) (PLLA), polylactide, poly(glycolic acid), polyesters, polydioxanone, poly(vinylidene fluoride) (PVDF), poly(vinylidene fluoride-co-hexafluoropropylene) (PVDF-co-HFP), polyacrylonitrile, poly(acrylonitrile-co-methacrylate), polymethylmethacrylate (PMMA), polyvinylchloride, poly(vinylidenechloride-co-acrylate), polyethylene, polypropylene, nylon, aramid, polybenzimidazole, poly(vinyl alcohol), cellulose, cellulose acetate, cellulose acetate butylate, polyvinyl pyrrolidone-vinyl acetates, poly(bis-(2-methoxy-ethoxyethoxy))phosphazene (MEEP), poly(ethyleneimide), poly(ethylene succinate), poly(ethylene sulphide), poly(oxymethylene-oligo-oxyethylene), poly(propyleneoxide), poly(vinylacetate), polyaniline, poly(ethylene terephthalate), poly(hydroxy butyrate), SBS copolymer, poly(lactic acid), poly(glutamic-co-leucine), poly-lactic-glycolide acid, poly(L-lactic acid-caprolactone), mixtures, copolymer and blends, copolymers, and terpolymers thereof. In particular, the at least one polymer may be PVDF, PVDF-co-HFP, polyvinylchloride, PMMA, PLLA, nylon, PSU, or mixtures, copolymer and blends, copolymers, and terpolymers thereof.

According to another particular aspect, the anti-wetting coating may have a high degree of transparency. “Transparency” may be as defined above. The anti-wetting coating having a high degree of transparency enables the coating to be applied on various surfaces such as surfaces of optical devices without affecting the visibility through the coated surface. For example, the anti-wetting coating may have a transparency of ≧90%. In particular, the anti-wetting coating may have a transparency of ≧95%. Even more in particular, the transparency of the anti-wetting coating is ≧97%. For example, the transparency of an anti-wetting coating comprising fibres formed from nylon was measured to be 98.5%; for an anti-wetting coating comprising fibres formed from poly(L-lactide), the transparency was measured to be 99.2%; for an anti-wetting coating comprising fibres formed from poly(methyl methacrylate), the transparency was measured to be 98.9%; for an anti-wetting coating comprising fibres formed from polysulfone, the transparency was measured to be 92.2%; and for an anti-wetting coating comprising fibres formed from poly(vinylidene fluoride), the transparency was measured to be 98.7%. The transparencies were measured using a UV spectrophotometer, as explained above.

The fibres comprised in the coating may be prepared according to any suitable method. For example, the fibres may be prepared according to the method described above. In particular, the fibres may be electrospun fibres. Even more in particular, the fibre may be formed from any suitable electrospinning method. An example of an electrospinning method is described above.

According to a particular aspect, the coating is such that after application of the coating on at least one surface of a substrate, the coated surface may exhibit anti-wetting and/or anti-dust properties.

In particular, the at least one surface of a substrate onto which the coating is applied may exhibit anti-wetting property upon liquid contact. The liquid may be water. The liquid may be in the form of liquid droplets. Even more in particular, when liquid contacts at least a part of the at least one surface of the substrate onto which the coating is applied and at least a part of the fibres, the liquid is stretched between the fibres to form a film over the at least one surface, thereby enabling the at least one surface to exhibit anti-wetting property.

For example, when liquid contacts at least a part of a surface of a substrate which is coated with the coating, the liquid is stretched between the fibres comprised in the coating. The liquid is stretched between and/or along the fibres and fuses with other liquid, if present. The liquid then forms a film over the coated surface of the substrate, thereby enabling the coated surface to exhibit anti-wetting properties. The fibres significantly increase the total surface tension by introducing line tension into the system. The liquid spreads along the fibre-substrate contacting line and repels air. The liquid then forms a layer or film, which minimises the energy of the system. For example, the liquid may be water.

In particular, the fibres possess high surface energy due to their one-dimensional structure, as described above. When a coating comprising the fibres is coated on a substrate surface, the fibres introduce more surface energy in the fibre-substrate system in the form of line tension. The hydrophilicity of the fibre-substrate system increases, thereby causing the coated surface to exhibit hydrophilicity or greater hydrophilicity compared to an uncoated surface. Once liquid contacts the coated surface of the substrate, the liquid falls within and/or between the pores formed in the mesh of fibres. The liquid contacts the fibres as well as the substrate. In order to minimise the total surface tension, the liquid is caused to stretch and/or spread within and/or between the pores and form a film over the coated surface. For example, the coated surface may be such that when liquid contacts the coated surface, the liquid infinitely spreads over the surface, leaving no visible drops of liquid on the surface.

According to another particular aspect, the coating is such that after the coating is applied on at least one surface of a substrate, the coated surface may exhibit anti-dust properties. The coating may comprise electrospun fibres. The coated surface may repel contaminants. An example of a contaminant is dust particles. During electrospinning, some residual charges get accumulated on the surface of the fibres and these charges aid to repel or remove dust and other particles, thereby achieving the self-cleaning function.

The coating may be applied on any suitable surface. The surface may be any suitable surface which requires anti-wetting, anti-rain, anti-fog and/or anti-dust properties. For example, the surface may be that of a mirror, a glass, a window, lens, automobile or aeroplane windshield, face shields, goggles, and the like. In particular, upon application of the coating on the surface, the surface exhibits hydrophilicity or greater hydrophilicity compared to an uncoated surface, as described above.

According to another aspect, the present invention provides an article of manufacture, wherein at least one surface of the article of manufacture is coated with the coating as described above, and wherein upon application of the coating on at least one surface of the substrate, the surface exhibits hydrophilicity or greater hydrophilicity compared to an uncoated surface. In particular, the at least one surface of the article of manufacture onto which the coating is applied may be hydrophobic, hydrophilic or amphiphilic before the coating is applied. Upon application of the coating on the at least one surface of the article of manufacture, the coated surface exhibits hydrophilicity or greater hydrophilicity compared to an uncoated surface of the article of manufacture. For example, the at least one surface may exhibit ≧30%, ≧35%, ≧40%, ≧45%, ≧50%, ≧55%, ≧60%, ≧65%, ≧70%, ≧75%, ≧80%, ≧85%, ≧90%, ≧95%, or 100% hydrophilicity upon application of the coating. In particular, the coated surface exhibits ≧90% hydrophilicity compared to an uncoated surface of the article of manufacture.

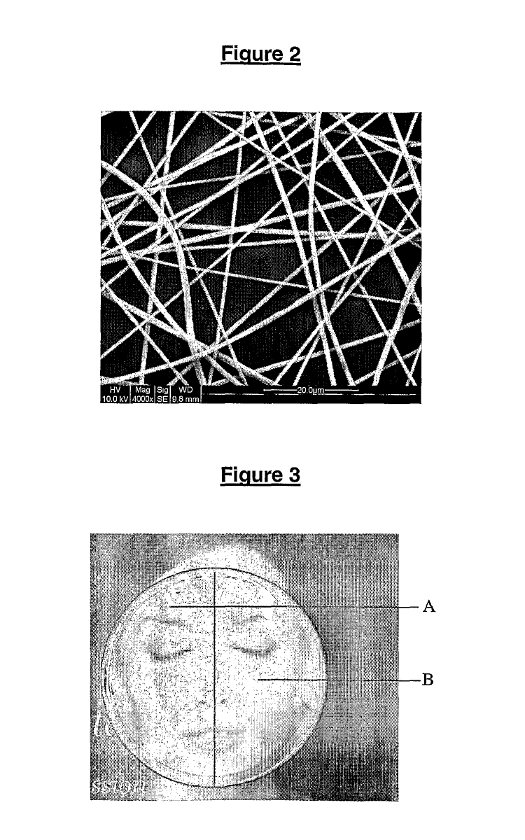

The coating coated on the at least one surface of the article of manufacture may have an appropriate thickness. For example, the coating may have a thickness which may be greater than or equal to the average diameter of a fibre comprised in the coating. According to a particular aspect, the thickness may be greater than or equal to the average diameter of a fibre but not more than about 10 times the average diameter of a fibre. In particular, the thickness is not more than about 9, 8, 7, 6, 5, 4, 3 or 2 times the average diameter of the fibre. Even more in particular, the thickness of the coating is about 2-3 times the average diameter of a fibre. The average diameter of a fibre may be as described above. The coating may be a single layer or more than two layers on the at least one surface of the article of manufacture. An example of a coating coated on a substrate is provided in FIG. 2. FIG. 2 shows a scanning electron microscope (SEM) picture of the coating according to the present invention coated on glass. The thickness of the coating is approximately 3-6 times the average diameter of a fibre.

The at least one surface of the article of manufacture on which the coating is applied need not be pre-cleaned prior to the application of the coating. This would save time and cost of producing an article of manufacture with the coating.

The article of manufacture may be any article of manufacture which requires at least one surface of the article of manufacture to have anti-wetting, anti-rain, anti-fog and/or anti-dust properties. For example, the article of manufacture may be a mirror, a glass, a window, lens, automobile or aeroplane windshield, face shields, goggles, and the like.

When the coating according to any aspect of the present invention is applied on at least one surface of a substrate or article of manufacture, the fibres comprised in the coating may bond to the surface of the substrate or article of manufacture by covalent bond, hydrogen bond, van der Waals forces of attraction or other adhesion forces. Accordingly, the coating does not come off the surface it is coated on too easily.

The at least one surface of the article of manufacture which is coated with the coating may exhibit anti-wetting and/or anti-dust properties. In particular, the at least one coated surface of article of manufacture may exhibit anti-wetting property upon liquid contact. The liquid may be water. The liquid may be in the form of liquid droplets. Even more in particular, when liquid, such as water, contacts at least a part of the at least one surface of the article of manufacture onto which the coating is coated, for example during rain, the liquid gets stretched between the fibres comprised in the coating to form a film which causes more liquid which contacts the surface to roll off the surface, thereby exhibiting anti-wetting property.

For example, when liquid contacts at least a part of the coated surface of the article of manufacture, the liquid is stretched between the fibres comprised in the coating. The liquid is stretched between and/or along the fibres and fuses with other liquid, if present. The liquid then forms a film over the coated surface of the article of manufacture, thereby enabling the coated surface to exhibit anti-wetting properties. The fibres significantly increase the total surface tension by introducing line tension into the system. The liquid spreads along the fibre-substrate contacting line and repels air. The liquid then forms a layer or film, which minimises the energy of the system.

In particular, the fibres possess high surface energy due to their one-dimensional structure, as described above. When a coating comprising the fibres is coated on at least one surface of the article of manufacture, the fibres introduce more surface energy in the fibre-article system in the form of line tension. The hydrophilicity of the fibre-article system increases, thereby causing the coated surface to exhibit hydrophilicity or greater hydrophilicity compared to an uncoated surface. Once liquid contacts the coated surface of the article of manufacture, the liquid falls within and/or between the pores formed in the mesh of fibres. The liquid contacts the fibres as well as the article of manufacture. In order to minimise the total surface tension, the liquid is caused to stretch and/or spread within and/or between the pores and form a film over the coated surface. For example, the coated surface may be such that when liquid contacts the coated surface, the liquid infinitely spreads over the surface, leaving no visible drops of liquid on the surface.

According to another particular aspect, the coating is such that after the coating is applied on at least one surface of the article of manufacture, the coated surface may exhibit anti-dust properties. The coating may comprise electrospun fibres. The coated surface may repel contaminants. An example of a contaminant is dust particles. During electrospinning, some residual charges get accumulated on the surface of the fibres and these charges aid to repel or remove dust and other particles, thereby achieving the self-cleaning function.

Further, due to the film formation and subsequent motion of liquid droplets falling on the coated surface, or the repulsion of particles, as explained above, the transparency and visibility through the coated surface is maintained. As the liquid droplets coalesce upon contact with the coated surface, no distinct boundaries which have different refractive indexes are formed on the coated surface. Accordingly, vision through the coated surface is not affected. Further, the fibres comprised in the coating are too small to be seen with the naked eye and therefore, vision through a coated surface is not affected by the application of the coating on the surface.

Having now generally described the invention, the same will be more readily understood through reference to the following examples which are provided by way of illustration, and are not intended to be limiting of the present invention.

### EXAMPLES

### Example 1

### Preparation of Coating

0.1 g/mL of poly(vinylidene fluoride-co-HFP) (PVDF-co-HFP) was dissolved in acetone to form a homogeneous liquefied polymer solution. All solutions were obtained from Sigma Aldrich, USA. In particular, the PVDF-co-HFP was of HPLC grade (http://www.sigmaaldrich.com/catalog/search/ProductDetail/ALDRICH/427160). The liquefied polymer solution was then electrospun into fibres by an electrospinning method, following the method described in Z M Huang et al, 2003. A high voltage of 10 kV was applied to the polymer solution and at a critical voltage, a jet of polymer solution was formed which was collected on a part of the grounded glass surface. The jet of polymer solution, upon cooling on the glass surface formed fibres with an average diameter of 250 nm. The average diameter of the fibres was measured using scanning electron microscopy (SEM).

### Example 2

### Wetting Characteristics of the Coating

Water was gently sprayed onto a glass surface coated with electropsun fibres from Example 1. At first, water droplets formed on the glass surface. When more water was sprayed onto the surface within a few seconds, the water droplets joined together and formed a thin layer of transparent water film. The water film remained stable regardless of the movement of the glass. The glass surface remained clear and transparent even as more water was sprayed onto the surface, or when water was drying out. The water on the glass surface dried out from the edge of the water film towards the middle of the film.

### Example 3

### Testing of Other Characteristics of the Coating

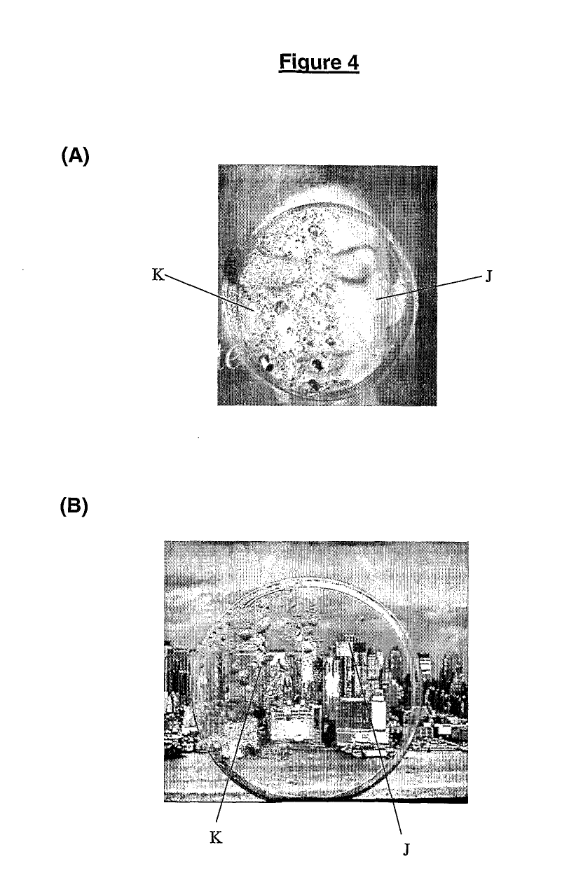

a) Visibility
   (i) The coating prepared according to Example 1 was coated on part of a glass surface. In this way, the glass had a part of its surface coated with the coating, and the other part uncoated. The glass was then placed over a picture and the visibility of the coated surface was compared with that of the uncoated surface. FIG. 3 shows the effect of coating a part of the surface of the glass. As shown in FIG. 3, the coating did not affect the visibility through the coated surface (indicated as “B”) as there was little or no difference in the image seen through the coated surface when compared to the uncoated glass surface (indicated as “A”).
   (ii) A piece of uncoated glass acting as the negative control was placed inside a UV spectrophotometer (Unicam UV-VIS 300 series spectrophotometer with vision data system—Thermo Spectronics) and its transmittance was measured for a wavelength range of 350-800 nm (corresponding to the wavelength of visible light). This was taken as the baseline transmittance. The same piece of glass was then coated with electrospun fibres prepared according to Example 1. The transmittance of light was then re-measured. The transmittance was calculated by taking the average transmittance over the wavelength range 350-800 nm. The transmittance was measured to be 98.7%.
b) Rain simulation tests
   Rain simulation tests were done in the laboratory on a glass surface partially coated with the coating prepared according to Example 1. The results are shown in FIG. 4A and FIG. 4B. In particular, the right side of the glass surface (marked as “J) was coated with the coating while the left side of the glass surface (marked as “K”) was left untreated. During the simulation, water droplets were sprayed on the glass surface. It was observed that droplets formed and settled on the uncoated surface, thereby affecting visibility whereas on the surface which was coated, the coating was able to stretch the water droplets and form a film which did not affect the visibility through the surface. As seen from FIGS. 4A and 4B, the visibility through the coated surface is as good as a dry glass surface.

### REFERENCES

1. Z M Huang et al, Composites Science and Technology, 62:2223-2253, 2003

1. A method of coating at least one surface of a substrate, the method comprising the step of applying a coating comprising fibres onto the at least one surface of the substrate, wherein upon application of the coating on the at least one surface of the substrate, the surface exhibits hydrophilicity or greater hydrophilicity compared to an uncoated surface.

2. The method according to claim 1, wherein the at least one surface of the substrate onto which the coating is applied exhibits ≧90% hydrophilicity compared to an uncoated surface of the substrate.

3. The method according to claim 1, wherein at least one of the fibres has a one-dimensional anisotropic structure comprising an aspect ratio such that the length of the fibre to its average diameter is ≧2.

4. The method according to claim 1, wherein the fibres form a mesh of fibres having a mesh porosity of 50%.

5. The method according to claim 4, wherein the mesh of fibres are such that adjacent fibres form pores having a pore size of 10 nm-10 mm.

6. (canceled)

7. The method according to claim 1, wherein the fibres comprised in the coating have an average diameter of ≦10 μm.

8. (canceled)

9. The method according to claim 1, wherein the fibres are formed from at least one hydrophobic polymer, hydrophilic polymer and/or amphiphilic polymer.

10. (canceled)

11. (canceled)

12. (canceled)

13. The method according to claim 1, wherein the at least one surface of the substrate onto which the coating is applied exhibits anti-wetting and/or anti-dust properties.

14. (canceled)

15. The method according to claim 13, wherein a liquid contacts at least a part of the at least one surface of the substrate onto which the coating is applied and at least a part of the fibres, the liquid being stretched between the fibres to form a film over the at least one surface, thereby enabling the at least one surface to exhibit anti-wetting property.

16. (canceled)

17. The method according to claim 1, wherein the coating has a transparency of ≧90%.

18. The method according to claim 1, wherein the method further comprises the steps of:
a) mixing at least one polymer and at least one solvent to form a mixture; and
b) electrospinning the mixture to form fibres, prior to the step of applying the coating onto the at least one surface of the substrate.

19. (canceled)

20. (canceled)

21. (canceled)

22. An article of manufacture, wherein at least one surface of the article of manufacture is coated according to the method of claim 1.

23. (canceled)

24. A coating for coating at least one surface of a substrate, wherein the coating comprises fibres, and wherein upon application of the coating on at least one surface of the substrate, the surface exhibits hydrophilicity or greater hydrophilicity compared to an uncoated surface.

25. The coating according to claim 24, wherein at least one of the fibres has a one-dimensional anisotropic structure comprising an aspect ratio such that the length of the fibre to its average diameter is ≧2.

26. The coating according to claim 24, wherein the fibres form a mesh of fibres having a mesh porosity of ≧50%.

27. The coating according to claim 26, wherein the mesh of fibres are such that adjacent fibres form pores having a pore size of 10 nm-10 mm.

28. (canceled)

29. The coating according to claim 24, wherein the fibres comprised in the coating have an average diameter of ≦10 μm.

30. (canceled)

31. The coating according to claim 24, wherein the fibres are formed from at least one hydrophobic polymer, hydrophilic polymer and/or amphiphilic polymer.

32. The coating according to claim 24, wherein upon application of the coating on at least one surface of a substrate, the surface exhibits anti-wetting and/or anti-dust properties.

33. (canceled)

34. The coating according to claim 24, wherein the coating has a transparency ≧90%.

35. (canceled)

36. (canceled)

37. (canceled)
